(19) United States
(12) Patent Application Publication
(10) Pub. No.: US 2004/0140396 A1
(43) Pub. Date: Jul. 22, 2004

(54) Toy aircraft

(76) Inventor: Lee Spector, Zurich (CH)

Correspondence Address: JACK SHORE, MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/336,987

(22) Filed: Jan. 6, 2003

Related U.S. Application Data
(60) Provisional application No. 60/344,799, filed on Jan. 7, 2002.

(51) Int. Cl. B64D 27/00

(52) U.S. Cl. 244/54

(57) ABSTRACT

The present invention in one embodiment includes an aircraft having a fuselage with a powered propeller. The aircraft further includes a cambered main wing positioned aft of the fuselage and has a non cambered portion connected to the fuselage. The main wing also has a reflexed trailing edge and a non cambered ridge portion extending under the fuselage. A depression positioned in the non cambered portion of the main wing causes the fuselage to set in an airflow pattern of the propeller. The main wing includes both oversized fins extending upwardly from the ends of the main wing and sub-fins extending downwardly from the ends. The aircraft also includes V-shaped control wing positioned fore of the main wing and connected to a top portion of the fuselage by a mechanism for moving the control wing. In addition, the propeller is rotatably connected aft of the fuselage and above the main wing.

### FIELD OF THE INVENTION

The present invention relates to aircraft with a forward control wing, and in particularly to aircraft in the hobby and toy industry.

### BACKGROUND OF THE INVENTION

Aircraft with a forward control wing are known in the prior art. In some instances, a canard or small wing is placed in front of the main wing, also known as tail first aircraft. Representative of canard style aircraft include U.S. Pat. No. 5,201,478; U.S. Pat. No. 5,320,306 and U.S. Pat. No. 5,407,150. In these patents the canards are fixed and do not provide any means for maneuverability. However, maneuverable canards are also known in the art, U.S. Pat. No. 5,020,740 discloses a pitch control trimming system for a canard designed aircraft. The aircraft includes a canard and a control surface or flap that is used to provide trim control during flight. In addition, the canard and the main wing are positioned substantially along a same longitudinal axis to provide aircraft trim.

Canards, however, are small and are not designed to provide a forward control surface in front of a main wing to produce a larger amount of lift. One prior art reference discovered, U.S. Pat. No. 3,985,317, does disclose an aircraft that includes a wing defined by multiple wing sections including a forward wing section and a rear wing section. Along the ends of the wing sections are movable rudders. However, the wing sections especially the forward wing section is fixed. As such, there are always a continual need for improvements and new and novel features.

### SUMMARY OF THE INVENTION

The present invention in one embodiment includes an aircraft having a fuselage with a powered propeller. The aircraft further includes a cambered main wing positioned aft of the fuselage. The main wing also includes a non cambered portion, which permits the fuselage to be secured above the main wing at the non cambered portion. The main wing also has a reflexed trailing edge and a non cambered ridge portion extending under the fuselage. A depression positioned in the non cambered portion of the main wing causes the fuselage to sit in an airflow pattern of the propeller. The main wing includes both oversized fins extending upwardly from the ends of the main wing and sub-fins extending downwardly from the ends. The aircraft also includes a V-shaped control wing positioned fore of the main wing and connected to a top portion of the fuselage by an anti-dive compensating mechanism. In addition, the propeller is rotatably connected aft of the fuselage and above the main wing.

Numerous advantages and features of the invention will become readily apparent from the following detailed description of the invention and the embodiments thereof, and from the accompanying drawings.

### BRIEF DESCRIPTION OF THE DRAWINGS

A fuller understanding of the foregoing may be had by reference to the accompanying drawings, wherein:

FIG. 1a is a perspective view of the invention;

FIG. 1b is an exploded view of the invention;

FIG. 1c is a front view thereof;

FIG. 1d is a sectional view about S-S, showing the U-shaped depression on each side of the fuselage interface;

FIG. 1e is a sectional view about C-C, showing the reflexed upward trailing edge of the main wing;

FIG. 1f is a sectional view about W-W, also showing the reflex in the main wing;

FIG. 1g is a sectional view about M-M, showing the internal air passage channel;

FIG. 2a is a partial top view of a front stabilizer showing the servo-arm or bellcrank attachment to the fuselage;

FIG. 2b is a top view showing the stabilizer moving to the right;

FIG. 2c is a rear view showing the left side of the stabilizer moving upwardly;

FIG. 2d is a partial view showing the servo-arm or bellcrank and the stabilizer as the servo-arm or bellcrank is moving to the right;

FIG. 2e is a partial perspective view showing the cradle in the fuselage;

FIG. 2f is a side view illustrating the rearward-tilted axis angle of the servo-arm or bellcrank; and

FIG. 3 is top view of another embodiment of the present invention.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

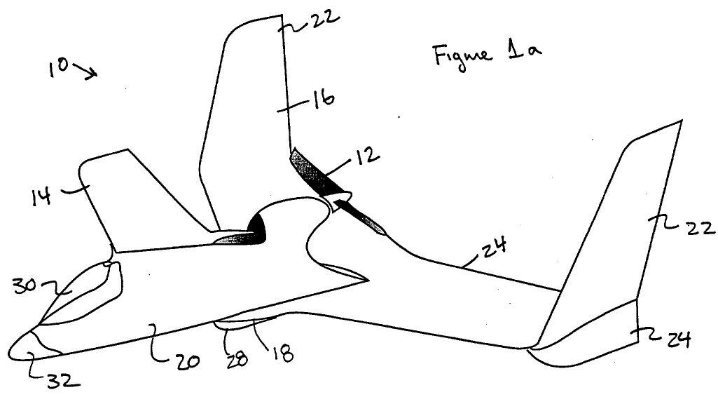

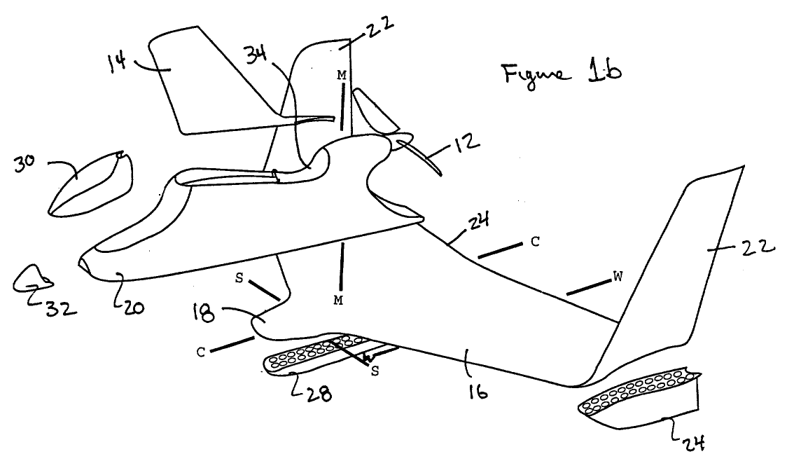

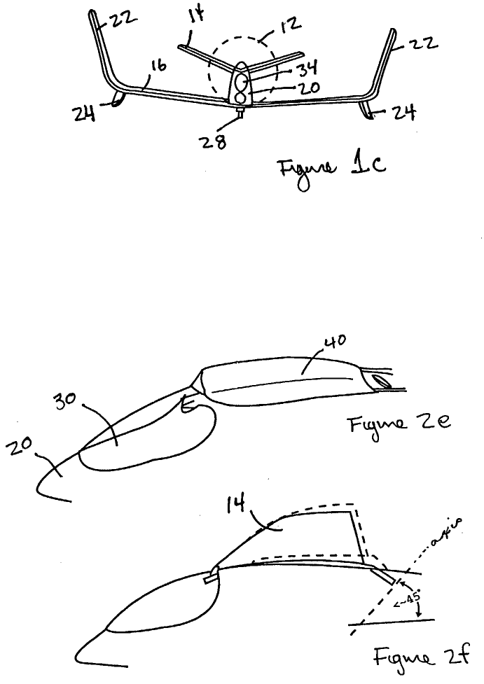

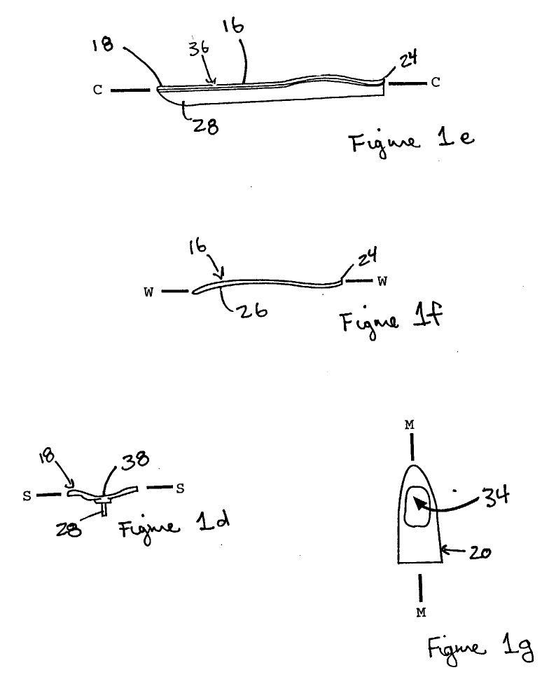

In reference to FIGS. 1a-1g, the invention is further discussed hereinbelow. An aircraft 10 is shown that may be operated by a user via a remote or radio controlled device (not shown). The aircraft includes a power mechanism (not shown) that rotates a propeller 12 that is located in a very central protected position, preferably shielded fore, aft, both sides, and bottom. The propeller 12 therefore is not able to strike anything external, including the user. This is for safety as well as restricting propeller breakage.

A forward stabilizer or control wing 14, is uniquely positioned longitudinally close to the front of a main wing 16 and uniquely high above it. This allows the centrally positioned propeller 12 to impel extra airflow from the control wing 14 over the main wing 16, creating more lift. The control wing 14 also vectors the thrust of the propeller 12 with this increased lift allowing extra-slow powered flight, or slower than non-powered gliding flight with vectored-thrust control for high maneuverability at all speeds.

The control wing 14 may be used as the sole control surface and may also use a unique, simple system to automatically keep the aircraft's nose up in turns, referred herein the anti-dive steering, discussed in greater detail below. Since aircraft naturally tend to spiral-dive in turns, without extra up-control input by the pilot, the downward-projection of the lifting surface is reduced in a turn-banked wing.

The control wing 14 can be vacuum-formed from inexpensive uniform-thickness sheet-foam plastic, or injection-molded, and use a cambered uniform-thickness airfoil section for strength and lift. The leading edge may be thinned and rounded for aerodynamic efficiency and durability. The control wing 14 has a slight dihedral and sweepback shape for stability and control-authority, and may include washout tips (not shown) at a lesser angle-of-attack for aerodynamic efficiency and stability. The tips may be swept outward to a point for vortex formation efficiency.

The main wing 16 has a forward strake 18 (shown in FIG. 1b), which allows a longer and larger interface with the fuselage 20 and which adds slightly to the aerodynamic stability and efficiency. Each wingtip of the main wing 16 has oversized slightly outwardly-splayed vertical fins 22 at a negative incidence and has smaller slightly outwardly-splayed sub-fins 24 at a greater negative incidence. The large upper vertical fins 22 may be formed in one piece as part of the main wing 16, or spliced or made removable. The sub-fins 24 may be made of thin flexible plastic for durability.

Referring now also to FIG. 1e, the camber 36 is removed in the center section of the main wing 16 just under and forward of the fuselage 20 and propeller 12, but remains intact behind it for lateral center-section strength. The forward strake 18, FIG. 1d, contains a “U”-shaped depression 38, which forms two parallel bends providing longitudinal strength to the center of the main wing 16 and correctly positions the fuselage 20. The depression 38 also lowers the fuselage 20 such that the fuselage is positioned within the airflow pattern of the propeller 12 that is also lower to the main wing 16 because of the depression 38. The trailing edge 24 of the main wing 16 is reflexed upward to counteract the forward-pitching aerodynamic effect of the strength-producing high camber 26, and aids in aerodynamic stabilization, shown in FIGS. 1e and 1f. Attached below the main wing 16 and running the front to the back of the main wing 16 is a lightweight plastic longitudinal member 28. The longitudinal member 28 strengthens the wing center section technically forming a continuation of the fuselage, allows hand-launching, and serves as a landing skid.

The fuselage 20, which is positioned below the control-wing 14 and above the main wing 16, may have a clear or tinted cockpit canopy 30 and a shock-absorbing elastic nose 32. Either of which may be made of injection-molded or vacuum formed lightweight foam, or other similar materials. The motor (not shown) is centrally located above the main wing 16 at the upper rear of the fuselage 20, and may be positioned with rearward anti-torque left-thrust for a counter-clockwise-turning propeller and positioned with stabilizing downthrust. The fuselage 20 may have an internal open channel 34 for air-passage, FIG. 1g, positioned below the motor for cooling and overall reducing air-resistance in the critical propwash area. The fuselage 20 may extend rearwardly under the motor towards the propeller tips for maximum wing interface and propeller/wing separation in the event of a sudden impact.

The control-wing 14, fuselage 20 and main wing 16 may be flexibly mounted to each other, by rubber-bands or metal or plastic springs, or clips such that they can absorb minor disturbing forces and return automatically to correct position but yet pop-apart on major impact without serious damage to the components. This also allows easy disassembly for packaging, transportation, and storage.

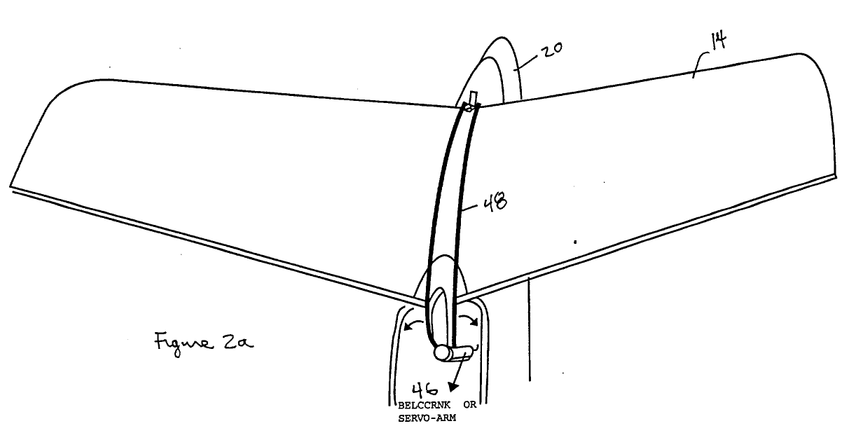

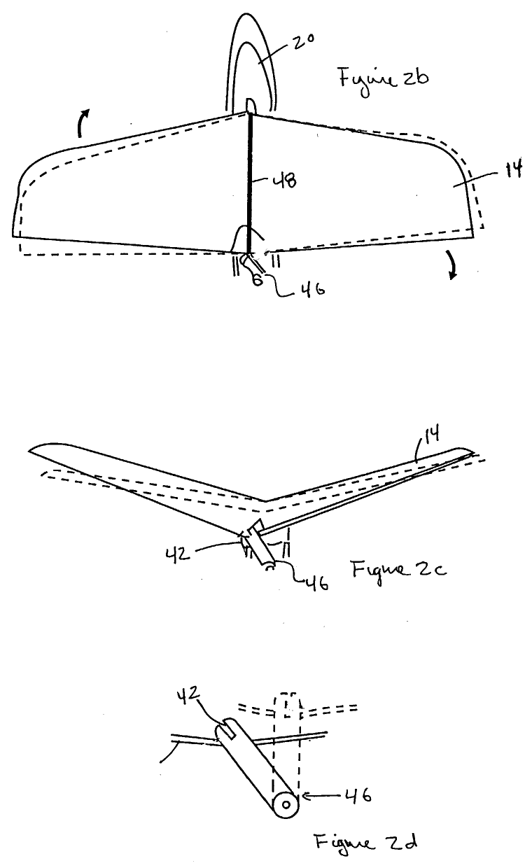

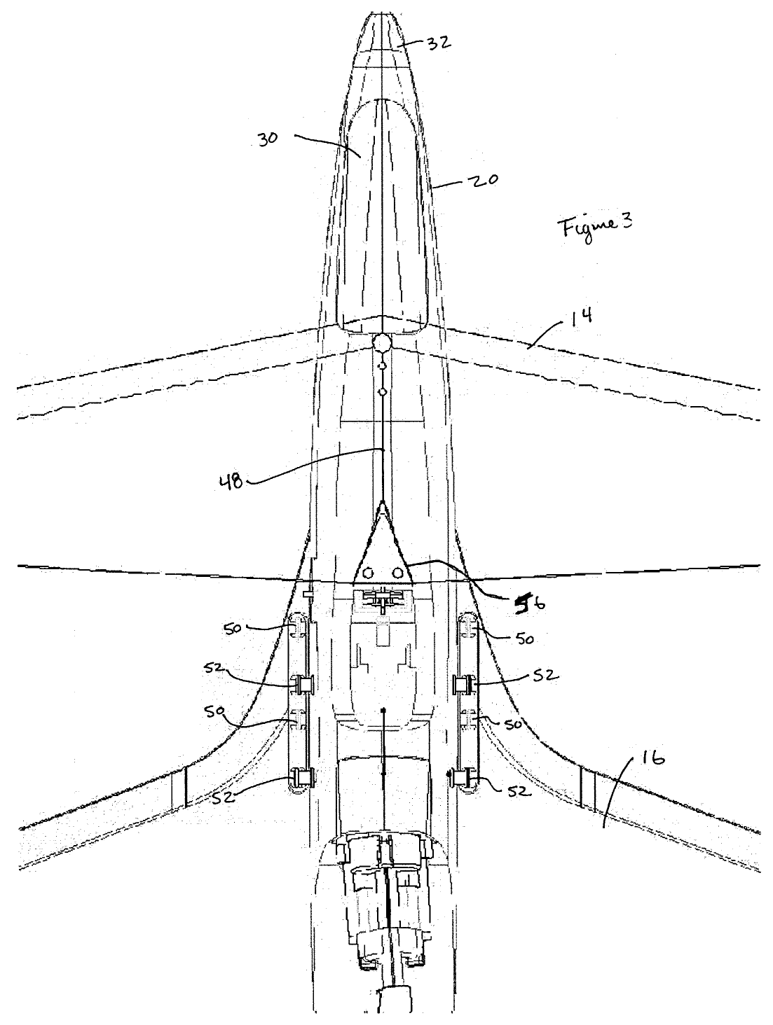

The following is in reference to FIGS. 2a-2g. The control wing 14 is in one embodiment shaped in a V-shaped dihedral and is cradled on top of the front end of a fuselage 20, in a matching V-shaped cradle 40 formed on the forward end of the fuselage 20. The rear portion of the cradle 40 has a diagonally extended wire 42 that fits into a slot 44 on an approximately 45° rearward-tilted axis bellcrank 46 or servo-arm. The control wing 14 is flexibly held in place by one or more bands 48, and is free to move fore-aft, yaw, and slightly tilt (roll) at the front cradle point. The rear follows a downward arc that can be more or less vertical or horizontal (lateral), depending on the exact angle of the tilted bellcrank 46 or servo-arm.

As the servo-arm or bellcrank 46 is rotated left or right of center it also descends and the rear of the control wing 14 does the same, increasing its angle of incidence and thus its lift. A swept-back control wing 14 presents a longer span on the desired side, due to the simultaneous rotation (as seen from FIG. 2b). In a right turn (FIG. 2e), for example, in which the rear of the control wing 14 is lowered to the left, and control wing 14 is rotated clockwise (as seen from FIGS. 2b and 2c), both effects produce: a) more overall lift for the entire stabilizer, keeping the aircraft nose up; b) more lift on the left side, rolling the aircraft to the right; c) a yaw to the right, with other effects yielding; and d) a perfectly balanced and coordinated turn.

The greater the lateral deflection of the rear of the control wing 14 and the corresponding tighter turn of the aircraft, the greater the control wing 14 rear's downward deflection and also corresponding nose-up influence.

The flexible mount allows the control wing 14 to be easily and quickly detached, also in the case of sudden impact (“pop-apart” design to deter control wing 14 breakage), with the ability to return to its original position if only slightly disturbed.

Referring now to FIG. 3, another embodiment of the present invention is shown. In this embodiment the fuselage 20 has two attachment positions with respect to the main wing 16, one slightly forward of the other. In a rear fuselage position (main wing 16 more forward) (indicated by clips 50) the center-of-gravity (C.G.) moves rearward, allowing very slow gentle flight, which may be more desirable for beginners, small flying spaces, or soaring. In a forward fuselage position (main wing 16 more rearward)(indicated by clips 52) the C.G. moves forward, allowing higher-speed flight, which may be more desirable for advanced fliers and windier conditions. The forward fuselage position also produces greater stability and decreased control-sensitivity due to the increased moment-arm length among the centers-of-lift, gravity, and the control wing 14.

In addition, a servo-arm 56 is used to move the control wing 14. The band is fastened to the control wing by connected it to the servo-arm 56 and a front attachment 58 by the cockpit canopy 30. The servo-arm 56 is preferably controlled by a motor mechanism that is ultimately controlled by a circuit board and a remote control unit by a user. The user inputs turning controls through the remote control unit to move the control wing 14 through the servo-arm 56. The servo-arm 56 moves the control wing 14 accordingly as described herein, which prevents the aircraft 10 from diving during a banking maneuver.

From the foregoing and as mentioned above, it will be observed that numerous variations and modifications may be effected without departing from the spirit and scope of the novel concept of the invention. For example, besides the radio controlled, remote controlled, or free-flight aircraft the invention may also be purely reaction powered, such as by a rocket, or fly gravity-powered as a glider or updraft-powered as a sailplane. It is to be understood that no limitation with respect to the specific methods and apparatus illustrated herein is intended or should be inferred.

I claim:

1. An aircraft including a fuselage having a defined rear end, front end, underside and topside, the fuselage further having a power means for propelling the aircraft, the improvement comprising:
a cambered main wing attached to the underside of the fuselage about the rear end thereof such that a portion of the main wing extends beyond the rear end of the fuselage, the main wing having a non cambered portion that is attached to said underside of the fuselage, and the main wing also having a reflexed trailing edge;
a moveable control wing positioned about the topside of said fuselage and about the front end thereof such that the control wing is positioned in front of and above the main wing;
a mechanism for moving the control wing movable attached to the fuselage and secured to the control wing; and
a propeller in communication with the power means, the propeller rotatably connected to the rear end of the fuselage above the main wing.

2. The aircraft of claim 1, wherein the non cambered portion of said main wing includes a depression for lowering the fuselage such that the main wing is positioned in an airflow pattern of the propeller.

3. The aircraft of claim 2, wherein the main wing includes a centered ridge portion extending under the fuselage towards the front end of the fuselage.

4. The aircraft of claim 3, wherein the main wing includes oversized fins extending upwardly and outwardly at a negative incidence about ends defined on the main wing and subfins extending downwardly and outwardly at a negative incidence about said ends.

5. The aircraft of claim 1, wherein the main wing includes a longitudinal skid aligned with the fuselage and connected to a bottom portion of the main wing.

6. The aircraft of claim 1, wherein the mechanism for moving the control wing is a bellcrank.

7. The aircraft of claim 1, wherein the mechanism for moving the control wing is a servo-arm.

8. An aircraft including a fuselage having a power means for propelling the same, the improvement comprising:
a cambered main wing positioned aft of the fuselage and having a non cambered portion connected to said fuselage, the main wing also having a reflexed trailing edge and a non cambered ridge portion extending under the fuselage;
a propeller rotatably connected to the power means aft of the fuselage and above the main wing;
a depression positioned in the non cambered portion of said main wing such that the fuselage is lowered to a position in an airflow pattern of the propeller;
oversized fins extending upwardly and outwardly about ends defined on the main wing and sub-fins extending downwardly and outwardly about said ends; and
a V-shaped control wing positioned fore of the main wing and connected to a top portion of said fuselage by an mechanism for moving the control wing.

9. The aircraft of claim 8, wherein the mechanism for moving the control wing includes a servo-arm that is movably attached to the fuselage and secured to a rear portion of the control wing, the servo-arm having a means to tilt the control wing and a means to lift a front portion defined on the control wing such that as the aircraft is banking, an angle of incidence, defined by the control wing, increases.

10. The aircraft of claim 8, wherein the mechanism for moving the control wing includes a bellcrank that is movably attached to the fuselage and secured to a rear portion of the control wing, the servo-arm having a means to tilt the control wing and a means to lift a front portion defined on the control wing such that as the aircraft is banking, an angle of incidence, defined by the control wing, increases.

11. The aircraft of claim 8 wherein the fuselage includes
a first main wing attachment means and a second main wing attachment means, wherein the first main wing attachment means attaches the main wing more aft than the second main wing attachment means.
